(19) United States
(12) Patent Application Publication
(10) Pub. No.: US 2025/0004515 A1
(43) Pub. Date: Jan. 2, 2025

(54) CONFIGURABLE MESH NETWORK NODE AGGREGATION FOR MITIGATING VOLTAGE DROOP IN AN INTEGRATED CIRCUIT (IC) CHIP AND RELATED METHODS

(71) Applicant: Microsoft Technology Licensing, LLC, Redmond, WA (US)

(72) Inventors: Ann Hampton THOMAS, Raleigh, NC (US); Richard Gerard HOFMANN, Cary, NC (US); Thomas BASNIGHT, Raleigh, NC (US); Mohammed A. EL-TANANI, Hillsboro, OR (US)

(21) Appl. No.: 18/217,274

(22) Filed: Jun. 30, 2023

(51) Int. Cl. G06F 1/26

(52) U.S. Cl. CPC G06F 1/26

(57) ABSTRACT

Aggregation circuits provided in each of the nodes of an IC chip are employed to, based on indications of power consumption in an aggregation zone of the IC chip, reduce power consumption in the nodes in the aggregation zone to mitigate voltage droop. Each aggregation zone includes a first node that receives indications of power consumption associated with the first node and indications of power consumption associated with other nodes in the aggregation zone. The first node generates a control signal based on the received indications, and each of the plurality of nodes in the aggregation zone reduces power consumption based on the control signal. In some examples, the aggregation circuit in any node may be configured to operate in a first mode as the first node or in a second mode as one of the second nodes, providing flexibility in the configuration of aggregation zones.

### FIELD OF THE DISCLOSURE

The technology of the disclosure relates generally to reducing voltage droop in an integrated circuit and, more particularly, to minimizing current spikes by controlling circuit switching.

### BACKGROUND

To reduce the package sizes of technologies employed for high-performance processing capabilities, the number of processing circuits provided in an integrated circuit (IC) chip has continued to increase. Communication of data among the many processing circuits can create congestion in the IC chip. One approach to handling data processed by the many processing circuits is to employ a mesh network in which each of the processing circuits is coupled to a node of the network and data is passed from node to node over segments of the network. In the nodes, the number of circuits switching due to data transmissions in a given system clock cycle varies from node to node depending on the respective processing circuits. Thus, the power needs among the nodes can shift frequently and the power levels in regions of the IC chip can rise suddenly. In such situations, the demand for current on the power rail providing a power supply voltage to these regions increases suddenly. Capacitance of the power distribution network within the IC chip may discharge in response to a sudden current increase, causing a voltage level on the power supply rail to droop temporarily. To avoid having the power supply voltage on the power rail drop below a minimum voltage, below which the processing circuits may not continue to operate normally, the nominal voltage level maintained on the power rail may be constantly maintained at a higher level to provide a voltage margin. However, maintaining a higher nominal voltage level on the power rail increases the power consumption of the IC chip, which may cause heat-related problems and will reduce battery life in mobile devices. Circuits and methods for avoiding voltage droop in the nodes in a mesh network without simply increasing power supply voltage to the entire IC chip would save power and avoid excessive heat generation.

### SUMMARY

Aspects disclosed in the detailed description include configurable mesh network node aggregation for mitigating voltage droop in an integrated circuit (IC) chip. Related methods of configurably aggregating mesh network nodes to mitigate voltage droop are also disclosed. A sudden increase in the demand for current in a node in a mesh network on an IC chip, known as a di/dt event, can cause a droop in the power supply voltage in a power supply rail coupled to the node. This problem may occur in individual nodes or in regions of the IC chip due to data transmissions among multiple adjacent nodes on the mesh network. The IC chip may have multiple such regions, which can be identified through testing. Exemplary aggregation circuits provided in each of the nodes of the IC chip can be employed to, based on indications of power consumption in an aggregation zone of the IC chip, reduce power consumption in the nodes in the aggregation zone to mitigate voltage droop. In particular, each aggregation zone includes a first node (also referred to herein as a “leader” node) that receives indications of power consumption associated with the first node and indications of power consumption associated with each of the other nodes in the aggregation zone. The first node generates a control signal based on the received indications, and each of the plurality of nodes in the aggregation zone reduces power consumption based on the control signal. In some examples, the aggregation circuit in any node may be configured to operate in a first, leader mode or in a second, follower mode, providing flexibility in the configuration of aggregation zones. In some examples, the aggregation circuits in some nodes in an aggregation zone are configured in a third, middle mode that receives the indications of power consumption from nodes in the second, follower mode and provides the indications to the first node. In addition, in such examples, the nodes in the third, middle mode can receive the control signal from the first node and provide the first control signal to the nodes in the second, follower mode.

In this regard, an IC chip is disclosed. The IC chip includes a plurality of nodes in a mesh network. The IC chip further includes a first aggregation zone comprising a first node and at least a second node of the plurality of nodes wherein each node of the plurality of nodes comprises an aggregation circuit configured to receive a first indication of power consumption associated with the node, the aggregation circuit in the first node is configured to, in response to operating in a first mode: receive at least a second indication of power consumption associated with each of the at least a second node and provide a first control signal based on the first indication and the at least a second indication to each node of the at least a second node, and the aggregation circuit in each of the first node and the at least a second node is configured to reduce power consumption in the node in response to the first control signal.

In another aspect, a method in an IC chip is disclosed. The method includes in a first aggregation zone comprising a first node and at least a second node of the plurality of nodes in a mesh network receiving, in an aggregation circuit in each node of the plurality of nodes, a first indication of power consumption associated with the node. The method further includes in response to the aggregation circuit in the first node configured to operate in a first mode receiving, in the first node, at least a second indication of power consumption associated with each of the at least a second node and providing a first control signal based on the first indication and the at least a second indication to each node of the at least a second node and in the aggregation circuit in each of the first node and the at least a second node, reducing power consumption in the node in response to the first control signal.

### BRIEF DESCRIPTION OF THE DRAWING FIGURES

FIG. 1 is a block diagram of an integrated circuit (IC) chip, including nodes interconnected in a mesh network;

FIG. 2 is a graph illustrating voltage changing over time in response to a current load step which produces first, second, and third-order voltage droops:

FIG. 3 is a block diagram of an exemplary node coupled to segments of a mesh network and comprising an aggregation circuit that may be employed to configure an aggregation zone for mitigating voltage droops in a region, including the node in an IC chip:

FIG. 4 is a block diagram of an exemplary aggregation circuit disposed in each node of a mesh network in an IC chip and configurable to operate in one of a plurality of modes in an aggregation zone for mitigating voltage droops in a region of an IC, including the node:

FIG. 5 is a block diagram of an IC chip in which a plurality of nodes are configured in a first example of aggregation zones that receive indications of power consumption and reduce power consumption in each of the plurality of nodes in the aggregation zone to mitigate voltage droops:

FIG. 6 is a flowchart of a method in an aggregation circuit in an IC chip configured to form at least one aggregation zone comprising a plurality of nodes to mitigate voltage droops:

FIG. 7 is a block diagram of a node including a plurality of router circuits coupled to segments of the mesh network and configured to reduce power consumption in the node in response to a control signal:

FIG. 8 is a block diagram of an IC chip in which a plurality of nodes are configured in a second example of aggregation zones that receive indications of power consumption and reduce power consumption in each of the plurality of nodes in the aggregation zone to mitigate voltage droops:

FIG. 9 is a block diagram of an IC chip in which a plurality of nodes are configured in a third example of aggregation zones that receive indications of power consumption and reduce power consumption in each of the plurality of nodes in the aggregation zone to mitigate voltage droops; and

FIG. 10 is a block diagram of an exemplary processor-based system that can include an IC chip including nodes in a mesh network, each node including an exemplary aggregation circuit to configure the nodes in aggregation zones to reduce power consumption to mitigate voltage droop in a region of the IC chip, as shown in FIGS. 3-5 and 7-9.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include configurable mesh network node aggregation for mitigating voltage droop in an integrated circuit (IC) chip. Related methods of configurably aggregating mesh network nodes to mitigate voltage droop are also disclosed. A sudden increase in the demand for current in a node in a mesh network on an IC chip, known as a di/dt event, can cause a droop in the power supply voltage in a power supply rail coupled to the node. This problem may occur in individual nodes or in regions of the IC chip due to data transmissions among multiple adjacent nodes on the mesh network. The IC chip may have multiple such regions, which can be identified through testing. Exemplary aggregation circuits provided in each of the nodes of the IC chip can be employed, based on indications of power consumption in an aggregation zone of the IC chip, to reduce power consumption in the nodes in the aggregation zone to mitigate voltage droop. In particular, each aggregation zone includes a first node (also referred to herein as a “leader” node) that receives indications of power consumption associated with the first node and indications of power consumption associated with each of the other nodes in the aggregation zone. The first node generates a control signal based on the received indications, and each of the plurality of nodes in the aggregation zone reduces power consumption based on the control signal. In some examples, the aggregation circuit in any node may be configured to operate in a first, leader mode or in a second, follower mode, providing flexibility in the configuration of aggregation zones. In some examples, the aggregation circuits in some nodes in an aggregation zone are configured in a third, middle mode that receives the indications of power consumption from nodes in the second, follower mode and provides the indications to the first node. In addition, in such examples, the nodes in the third, middle mode can receive the control signal from the first node and provide the first control signal to the nodes in the second, follower mode.

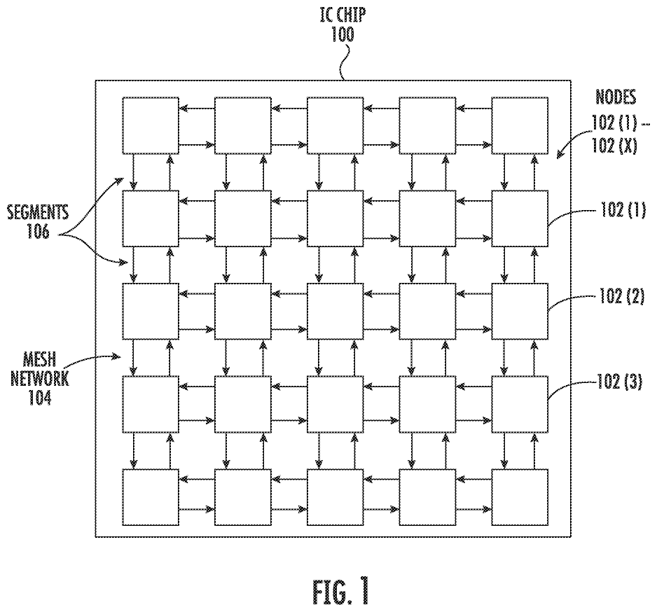

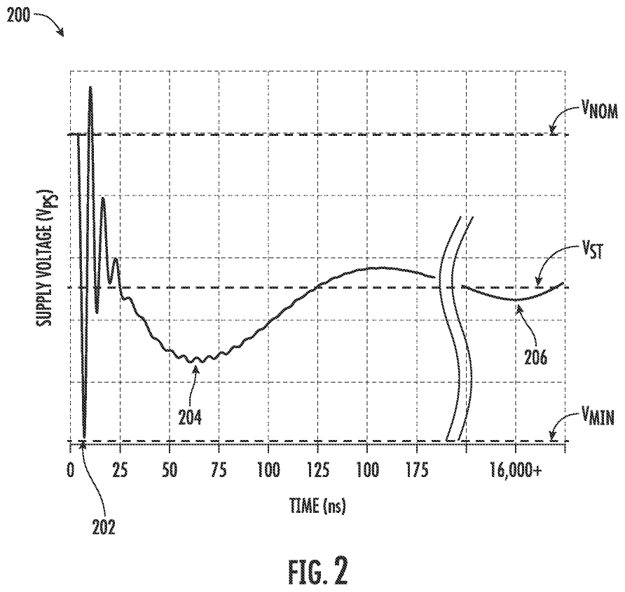

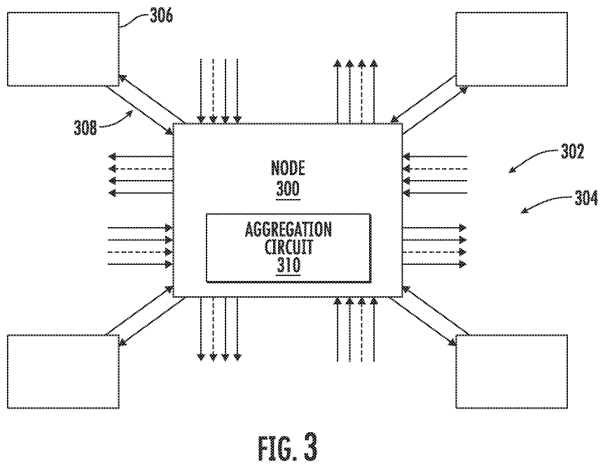

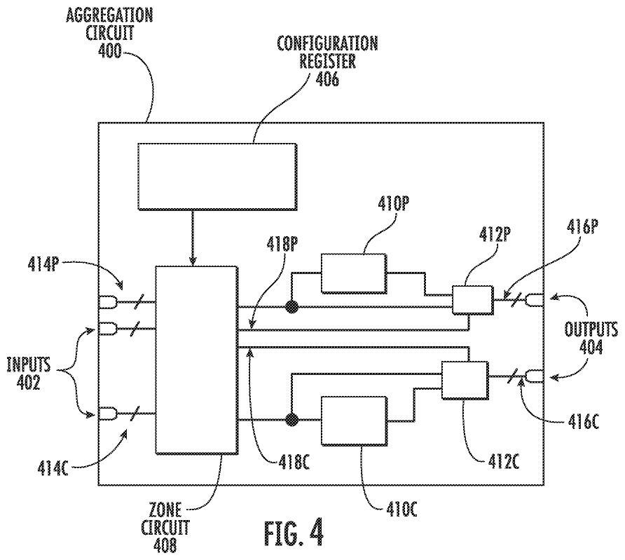

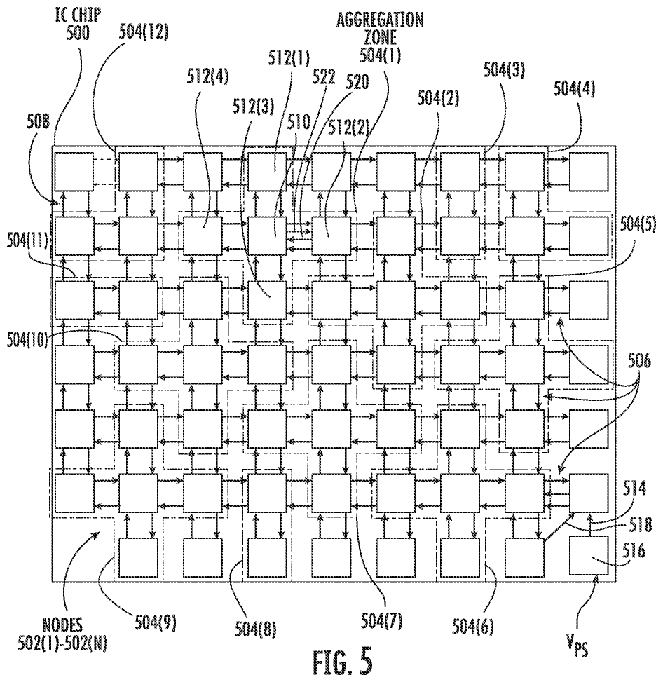

Before describing exemplary aspects of an aggregation circuit 310 and 400 in FIGS. 3 and 4, employed in each node of a mesh network of an IC chip to configure aggregation zones to mitigate voltage droop, an IC chip 100 comprising a plurality of nodes 102(1)-102(X) is first described with reference to FIG. 1, and an illustration of voltage droop in the IC chip 100 is described with reference to FIG. 2.

The IC chip 100 may be a system-on-chip (SOC) and may include many processing circuits (not shown here) that are each coupled to one of the plurality of nodes 102(1)-102(X) (referred to collectively as nodes 102) in a mesh network 104. The nodes 102 are coupled to each other by segments 106 of the mesh network 104. That is, each of the segments 106 is coupled between a first node 102(1) and a second node 102(2) that are adjacent to each other, for example. Each of the nodes 102(1)-102(X) is coupled to at least two segments of the mesh network 104. The segments 106 have a significant capacitance due to their length. Therefore, switching the data that is transmitted on the segments 106 in each cycle of a system clock CLK causes a significant amount of power to be consumed by driver circuits (not shown) that drive the data. The system clock CLK is employed to trigger the flow of data through sequential circuits and provide synchronization in the IC chip 100.

Consuming a significant amount of power in any of the nodes 102 in a short period of time (e.g., a high power consumption rate) imposes a demand for a high level of current to be provided to those nodes 102. As noted above, data transmissions on the segments 106 are a significant source of such power consumption. In circumstances in which there is a sudden increase from a low power consumption state, in which there may be infrequent data transmissions, to a higher power consumption state, where data transmissions are occurring in every cycle or almost every cycle, there may be a sudden increase in the current demanded from a power rail that provides power to the nodes 102 transmitting data. A sudden increase in current (i) in a short period of time (t), known as a di/dt event, in a node 102 or group of nodes 102 in a region of the IC chip 100 may discharge capacitance of a power distribution network in the region of the IC chip 100 or within the entire IC chip 100 before a power management circuit (not shown) external to the IC chip 100 can respond and provide power at a higher rate.

As a result of the discharge of capacitance in the power distribution network, the power supply voltage on the power rail may suddenly drop when the available charge is consumed. When voltage in the processing circuits drops below a minimum threshold, the processing circuits and data drivers may not operate as expected, which can cause malfunctions in the IC chip 100. Such a drop in the power supply voltage is known as a voltage droop and is discussed in more detail with reference to FIG. 2.

FIG. 2 is graph 200 illustrating an example of a power supply voltage V_{PS} on a power supply rail in an IC chip without the exemplary aggregation circuit 400 in FIG. 4. FIG. 2 shows the power supply voltage V_{PS} changing over time (shown in nanoseconds (ns)) in response to a voltage droop. The graph 200 shows that a voltage droop reaction to a di/dt event may have up to three stages, referred to here as first, second, and third-order voltage droops, which can be identified by low points 202, 204, and 206, respectively, in the power supply voltage V_{PS}. These low points 202, 204, and 206 are each related to depletion of capacitance provided in the power distribution network to the IC chip 100 at different distances from the nodes 102. For example, the first-order droop shown as the low point 202 corresponds to a discharge of the capacitance of the power distribution network on the IC chip 100 itself. Capacitance on the IC chip 100 may be provided by coupling capacitors. Outside the IC chip 100, first-level power capacitors are typically coupled to the same substrate as the IC chip 100 in an IC package (not shown) or are otherwise located physically close to the IC chip 100. The low point 202 in the power supply voltage V_{PS} occurs before the charge from the first-level power capacitors can reach the power supply network internal to the IC chip 100. As the charge from the first-level power capacitors reaches the power supply network, the power supply voltage V_{PS} recovers and begins to stabilize. However, if the condition persists and/or is severe enough, the first-level power capacitors may also be fully discharged, leading to the second low point 204. In some examples, the capacitance of the first-level power capacitors is larger than the capacitance of the internal power supply network (e.g., the coupling capacitors), so the time to discharge the first-level power capacitors is longer, causing the second low point 204 to be reached more slowly.

A power management chip or voltage regulator (not shown) may be coupled to the IC package substrate for providing power to the IC chip 100. The power management chip is typically located farther from the IC chip 100 than the first-level power capacitors. Adjacent to the power management chip, the power distribution network providing power to the IC chip 100 includes one or more second-level power capacitor(s) having even greater capacitance than the first-level power capacitor(s). The second-level power capacitor(s) may also discharge before the second-level power capacitors coupled to the power management chip can provide charge to meet the current level demanded in the IC chip 100. The transition from the discharge of the second-level power capacitor(s) to a stabilization voltage V_{ST} of the power supply voltage V_{PS} is shown in FIG. 2 as the third low point 206. The power supply voltage V_{PS} will slowly recover from the stabilization voltage V_{ST} back to the nominal supply voltage V_{NOM} as each of the coupling capacitors, first-level power capacitors, and second-level power capacitors are recharged unless there is another di/dt event.

As shown in the example in FIG. 2, the first low point 202 causes the greatest reduction in the power supply voltage V_{PS}. In other examples, depending on relative capacitances of on-chip coupling capacitors and the first-level power capacitors, the low point 204 of the second order voltage droop may be lower than the low point 202. As noted above, circuits may begin to operate abnormally or unexpectedly as the power supply voltage V_{PS} drops below a minimum threshold voltage V_{MIN}. To avoid malfunctions in the circuits of the IC chip 100 when such voltage droops occur, the nominal supply voltage V_{NOM} provided to the IC chip 100 is set high enough that none of the first low point 202, the second low point 204, and the third low point 206 of the power supply voltage V_{PS} is below the minimum threshold voltage V_{MIN}. However, the nominal supply voltage V_{NOM}, which is determined in this example based on the first low point 202, is significantly higher than the minimum threshold voltage V_{MIN} needed to keep the circuits in the IC chip 100 operating normally. Since the power consumption of the IC chip 100 is based on the power supply voltage V_{PS}, which is elevated above the minimum threshold voltage V_{MIN} due to the voltage droop, it would be preferable to reduce the voltage droop, to reduce the nominal supply voltage V_{NOM} and reduce power consumption. Reducing power consumption reduces power-related heating and improves battery life in mobile devices that include the IC chip 100. Therefore, it would be beneficial to employ the aggregation circuit 400 and methods to mitigate voltage droop by avoiding sudden changes in the current level (e.g., di/dt events).

FIG. 3 is a block diagram illustrating an exemplary node 300 coupled to a plurality of segments 302 of a mesh network 304. Processing circuits 306 are coupled to the node 300 by interfaces 308. The node 300 may be any of the nodes 102 in FIG. 1, and the segments 302 may be the segments 106 in FIG. 1. FIG. 3 is provided to show more detail of the environment of the node 300 and the mesh network 304 and to show that an aggregation circuit 310 is included in each of the nodes 300. The aggregation circuit 310 may be configured to implement an aggregation zone, including the node 300, to mitigate voltage droops in a region of the IC chip 100, including the node 300.

The processing circuits 306 may include any kind of processor, processor core, and/or data storage circuits (e.g., cache memories or register files). The processing devices may quickly process large amounts of data based on sequences of instructions. The instructions and raw data for processing are transferred into the node 300 from another node before being provided to the processing circuits 306, and the data processed by the processing circuits 306 is transferred from the node 300 to another node over the mesh network 304 for further processing or storage. Thus, processing activity and events in the processing circuits 306 cause traffic (data transfers) on the segments 302 coupled to the node 300. In addition to all the traffic due to the processing circuits 306, data may also be transferred through the node 300 (e.g., node 102(2) in FIG. 1) from a processing circuit 306 in the first node 102(1) in FIG. 1 to a second node 102(3), further increasing the traffic level into and out of the intermediate node 102(2) above the traffic due to processing circuits 306 coupled to the node 300.

In this regard, power consumption in and around the node 300 may be primarily due to the processing circuits 306 as well as traffic through the node 300. In particular, a large portion of the power consumption associated with the node 300 may be due to data transmissions (e.g., data egresses) on the segments 302 from the node 300 because of the power required to charge the long wires of the segments 302 from the node 300 to an adjacent node (see FIG. 1). Aspects of the aggregation circuit 310 are further described with reference to FIG. 4 and FIG. 5.

FIG. 4 is a block diagram of an exemplary aggregation circuit 400 that may be disposed in the node 300 of the mesh network 304 in FIG. 3 and configurable to operate in one of a plurality of modes in a node 300 included in an aggregation zone for mitigating voltage droops in a region of the IC chip 100 in FIG. 1.

The aggregation circuit 400 includes a plurality of inputs 402 and outputs 404 that are described with reference to the respective modes in which the aggregation circuit 400 may be configured to operate. The aggregation circuit 400 includes a configuration register 406 that may be configured to selectively control the aggregation circuit 400 to operate in one of a first mode, a second mode, and a third mode. The configuration register 406 may be configured to include information about the aggregation zone in which the aggregation circuit 400 is included. The configuration register 406 may be programmed to include threshold information that is compared to indications of power consumption in the node 300 and, in some examples, also to indications of power consumption in other nodes in the aggregation zone. The aggregation circuit 400 includes a zone circuit 408 that receives signals on the inputs 402 and generates signals (described below) on the outputs 404. The aggregation circuit 400 also includes storage circuits 410P and 410C and selectors 412P and 412C. Signals 414P and 414C received at the inputs 402 may be employed to generate signals 416P and 416C on outputs 404. In some first examples, the signals 416P and/or 416C generated on the outputs 404 may be generated by the zone circuit 408 in a same cycle as the signals 414P and/or 414C are received at the inputs 402. In some second examples, the signals 416P and 416C are generated on the outputs 404 in a next cycle after the signals 414P and 414C are received on the inputs 402. In these second examples, the storage circuits 410P and 410C are provided to store the signals 416P and 416C for one or more cycles as needed. The selectors 412P and 412C are controlled by signals 418P and 418C to provide the signals 416P and 416C directly from the zone circuit 408 or from the storage circuits 410P and 410C. The storage circuits 410P and 410C may be employed due to timing constraints.

FIG. 5 is a block diagram of an IC chip 500 including a plurality of nodes 502(1)-502(N) that each include the aggregation circuit 400 in FIG. 4 to configure the plurality of nodes 502(1)-502(N) in respective aggregation zones 504(1)-504(Z). In this example, there are twelve 12 aggregation zones 504(1)-504(Z) (where Z=12). The IC chip 500 may be the IC chip 100 in FIG. 1. The plurality of nodes 502(1)-502(N) are interconnected by segments 506 of a mesh network 508. Aggregation zone 504(1) is described here as an example of the aggregation zones 504(1)-504(Z), which will not be described separately except as needed. The aggregation zone 504(1) includes a first, leader node 510, in which the aggregation circuit 400 is configured in a first, leader mode of operation. The aggregation zone 504(1) also includes second, follower nodes 512(1)-512(F), where F=4 in this example. Each aggregation zone 504(1)-504(Z) includes at least one second, follower node 512(1)-512(F). In the aggregation zones 504(1)-504(Z), the number of follower nodes 512(1)-512(F) may be equal to or less than a number of the segments 506 coupled to the leader node 510. Each of the leader node 510 and the follower nodes 512(1)-512(F) are among the plurality of nodes 502(1)-502(N). Each of the follower nodes 512(1)-512(F) is adjacent to the leader node 510, meaning that the follower nodes 512(1)-512(F) are each coupled to the leader node 510 by respective ones of the segments 506. In this example, the aggregation zones 504(1)-504(Z) may include up to four follower nodes 512(1)-512(F) adjacent to the leader node 510. The configuration register 406 in the aggregation circuit 400 may be configured to identify which of the nodes adjacent to the leader node 510 are included in the aggregation zone 504(1).

The aggregation circuits 400 in each of the plurality of nodes 502(1)-502(N) may be configured to receive an indication 514 of power consumption associated with the respective one of the nodes 502(1)-502(N). As an example, the aggregation circuit 400 in the node 502(1) receives the indication 514 of power consumption associated with the node 502(1). The indication 514 of power consumption associated with the node 502(1) may include an indication of a power supply voltage (e.g., on a power rail not shown here) that provides a power supply voltage to the node 502(1). In this regard, the IC chip 500 may include a voltage comparator 516 configured to compare the power supply voltage V_{PS} on a power rail (not shown) in the IC chip 500 to one or more threshold voltages and generate an output to indicate whether the power supply voltage is higher or lower than a threshold or is within a range between thresholds to indicate a voltage level. The indication 514 may include the output from the voltage comparator 516.

Alternatively, the indication 514 may include or be based on one or more indications of one or more activities or events related to a data transmission from the node 502(1). For example, the indication 514 may be an indication of activities or events occurring or scheduled to occur in the processing circuits 306 shown in FIG. 3 (and coupled to the node 502(1)) that may lead to data transmissions from the node 502(1) on one of the segments 506. The indication 514 is one of the signals 414P that may be received on the inputs 402 of the aggregation circuit 400.

In some examples, the aggregation circuit 400 in the node 502(1) may also receive indications 518 of activity or events in nodes adjacent to the node 502(1) (e.g., coupled to the node 502(1) by one of the segments 506), because activity and/or events in an adjacent node may be indicative of data transmissions that will also be occurring in the node 502(1). The indication 518 is one of the signals 414P that may also be received in the input 402 in the aggregation circuit 400 in FIG. 4.

In the plurality of nodes 502(1)-502(N), in the absence of the aggregations circuits 400, the indications 514 and 518 may be employed to identify circumstances in which a di/dt event may be occurring or may occur, and the power consumption or rate of change of power consumption needs to be reduced. In such situations, the plurality of nodes 502(1)-502(N) may, as explained further below, reduce power consumption by inhibiting data transmissions on the segments 506. Reduction of power consumption may also be realized by reducing other activity in the plurality of nodes 502(1)-502(N), and the aggregation circuits 400 are not limited in this regard.

However, the plurality of nodes 502(1)-502(N), including the aggregation circuit 400, may communicate cooperatively to mitigate voltage droops in a region or regions of the IC chip 500 by configuring the aggregation circuits 400 in aggregation zones 504(1)-504(Z), as follows. In the aggregation zone 504(1), the aggregation circuit 400 of the leader node 510 is configured to operate in the leader mode, and the aggregation circuit 400 of the follower nodes 512(1)-512(F) is configured to operate in the second mode. It should be understood that the aggregation circuit 400 in any of the nodes 502(1)-502(N) may be configured to operate in either the first mode or the second mode, thus making many different aggregation zone configurations possible. It should also be understood that operations of the aggregation circuit 400 in the leader node 510 and the follower nodes 512(1)-512(F) may be referred to as the operations of the leader node 510 and the follower nodes 512(1)-512(F).

Once configured in the second mode of operation, rather than responding directly to the indications 514 and 518 by reducing their own data transmissions, each of the follower nodes 512(1)-512(F) generates, in the zone circuit 408 of the aggregation circuit 400, an indication 520 of the power consumption and provides the indication 520 on the outputs 404 of the aggregation circuit 400. In this example, the indication 520 is provided to the leader node 510 in the aggregation zone 504(1). The indication 520 may be one of the signals 416P in FIG. 4.

In the first mode of operation, in addition to receiving its own indications 514 and 518, the leader node 510 receives the indications 520 of all the follower nodes 512(1)-512(F). Based on the indications 514, 518, and 520 received in the leader node 510, the aggregation circuit 400 in the leader node 510 generates a control signal 522 to reduce power consumption in the leader node 510 and all the follower nodes 512(1)-512(F). In other words, the control signal 522 may be employed to reduce power consumption in each of the plurality of nodes 502(1)-502(N) that are in the aggregation zone 504(1). The control signal 522 may be generated in the zone circuit 408 in FIG. 4 and provided on the outputs 404. In the leader node 510, the control signal 522 may be one of the signals 416C in FIG. 4. The control signal 522 may be generated based on a summation, combination, or algorithm of the indications 514, 518, and 520 in a single cycle or multiple cycles of the system clock CLK. In this regard, the indications 514, 518, and 520 may be used to produce a value that is compared to a configurable threshold in the configuration register 406 in the aggregation circuit 400. The control signal 522 may be provided to each of the follower nodes 512(1)-512(F) and employed by each of the follower nodes 512(1)-512(F), in addition to the leader node 510, to reduce power consumption, which may include inhibiting data transmissions. In the follower nodes 512(1)-512(F), the control signal 522 may be one of the signals 414C in FIG. 4.

As in the aggregation zone 504(1), each of the aggregation zones 504(2)-504(Z) includes a respective leader node operating in the first mode to reduce power consumption in response to a control signal provided by the leader node in the follower nodes operating in the second mode.

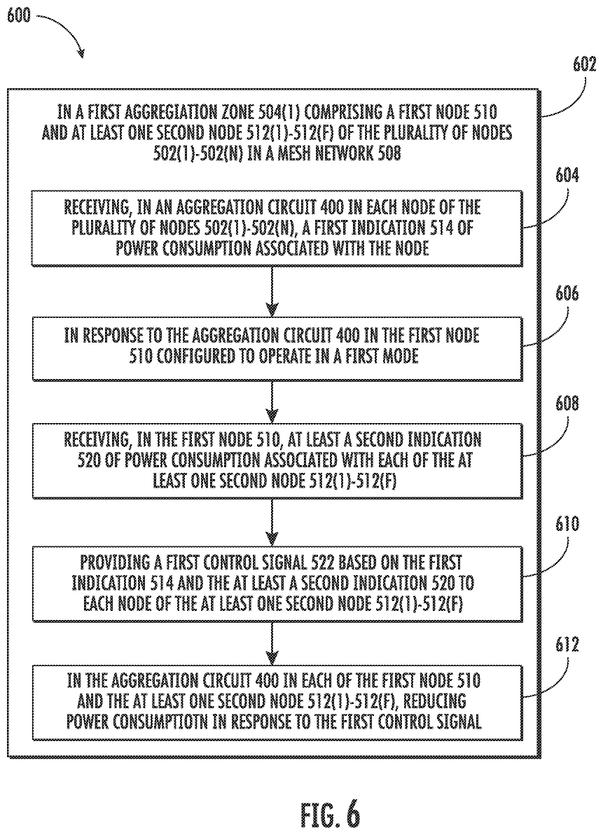

FIG. 6 is a flowchart of a method 600 of an IC chip 500. The method 600 includes, in a first aggregation zone 504(1) comprising a first node 510 and at least one second node 512(1)-512(F) of the plurality of nodes 502(1)-502(N) in a mesh network 508 (block 602), receiving, in an aggregation circuit 400 in each node of the plurality of nodes 502(1)-502(N), a first indication 514 of power consumption associated with the node (block 604). The method 600 further includes, in response to the aggregation circuit 400 in the leader node 510 configured to operate in a first mode (block 606), receiving, in the leader node 510, at least a second indication 520 of power consumption associated with each of the at least one follower node 512(1)-512(F) (block 608); and providing a first control signal 522 based on the first indication 514 and the at least a second indication 520 to each node of the at least one follower node 512(1)-512(F) (block 610). The method 600 further includes, in the aggregation circuit 400 in each of the leader node 510 and the at least one follower node 512(1)-512(F), reducing power consumption in response to the first control signal 522 (block 612).

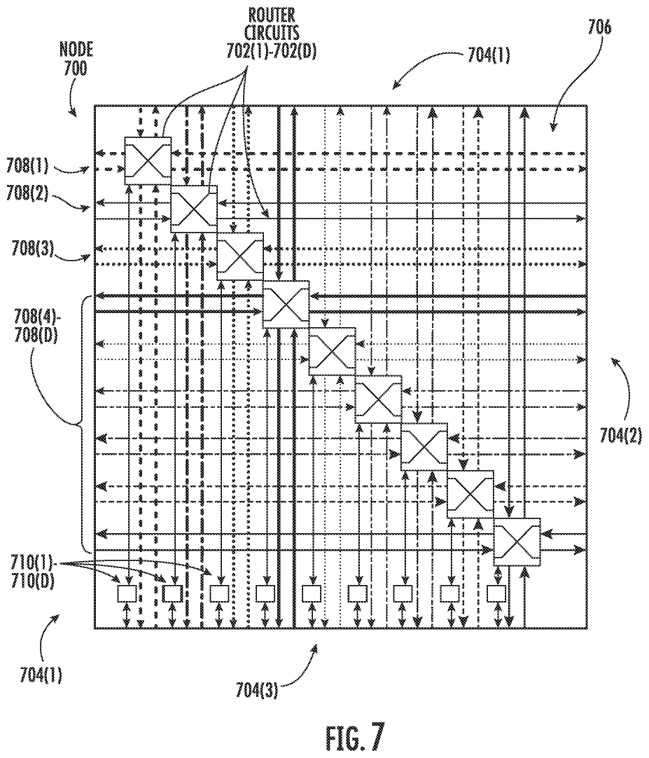

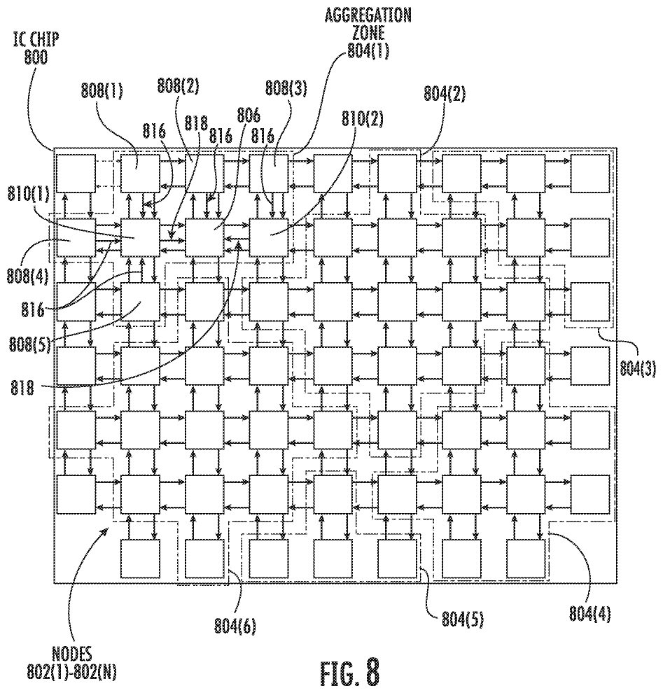

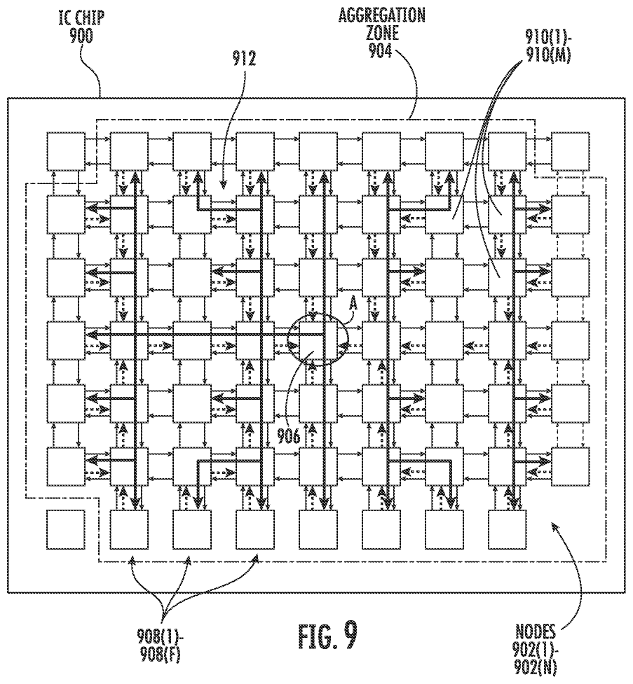

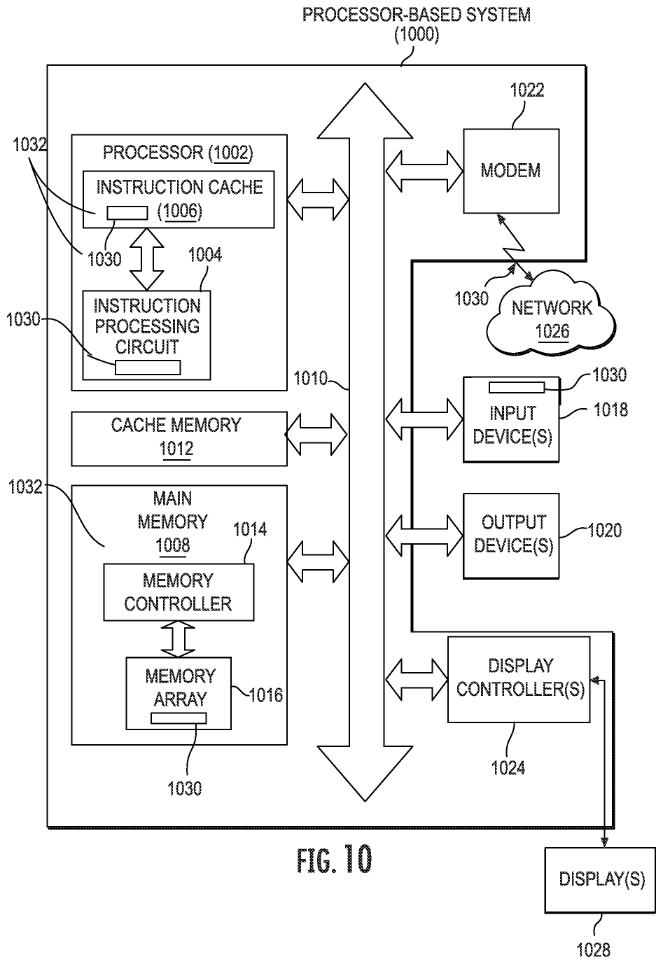

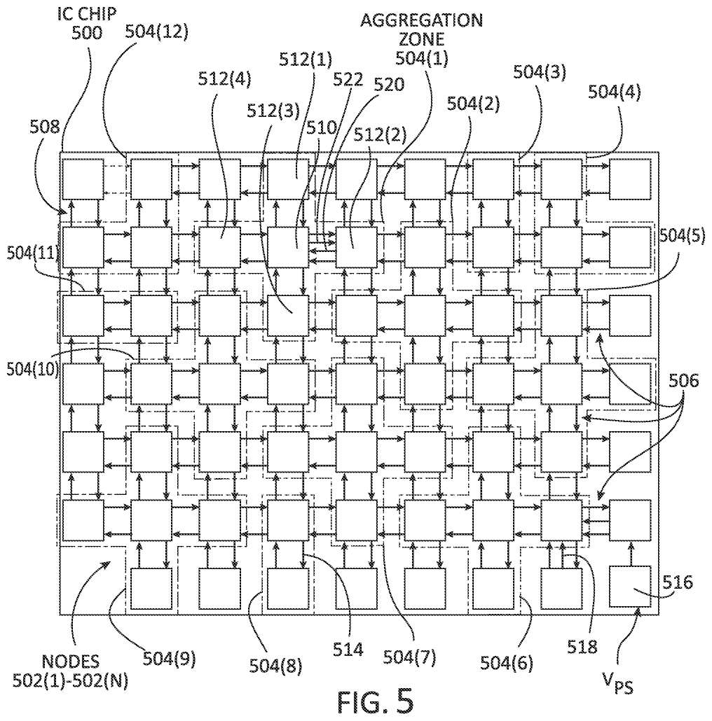

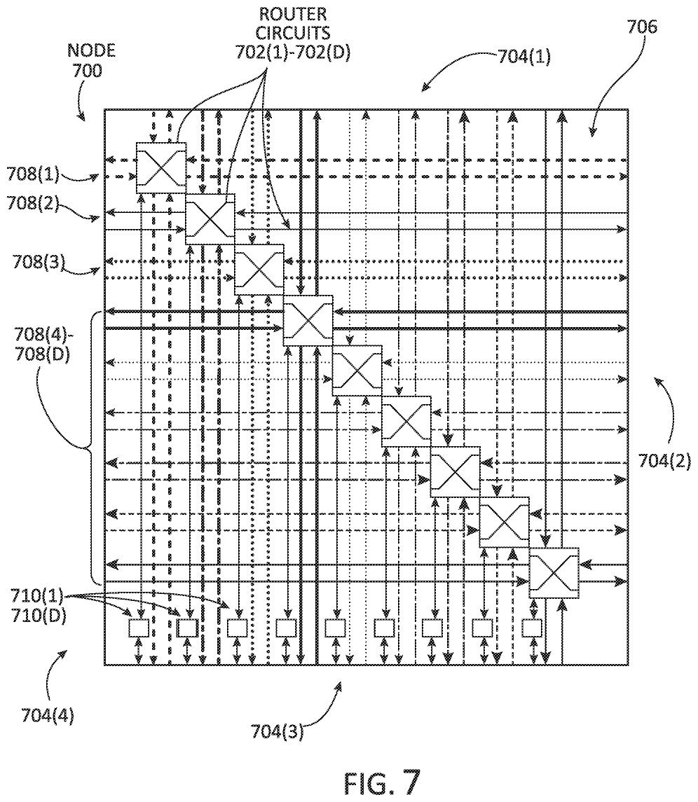

FIG. 7 is a block diagram of a node 700, including a plurality of router circuits 702(1)-702(D) coupled to segments 704(1)-704(4) of a mesh network 706 and configured to reduce power consumption in the node 700 in response to a control signal such as the control signal 522 in FIG. 5 (not shown here). The node 700 may be the node 300 in FIG. 3 and any of the plurality of nodes 502(1)-502(N) in FIG. 5. The segments 704(1)-704(4) each include multiple channels 708(1)-708(D) and the router circuits 702(1)-702(D) each couple to a corresponding one of the channels 708(1)-708(D) in each of the segments 704(1)-704(4). The router circuits 702(1)-702(D) provide a routing or switching capability and may selectively receive and transmit data on any one of the segments 704(1)-704(4). FIG. 7 is provided to illustrate one example of a method in which power consumption in the node 700 can be reduced. In particular, the power consumption in the node 700 may be reduced by reducing a number of data transmissions from the router circuits 702(1)-702(D). For example, router control circuits 710(1)-710(D) may receive the control signal 522 shown in FIG. 5, and this is taken as an indication to control the router circuits 702(1)-702(D) to inhibit data transmissions in some number or pattern of cycles over a period of cycles. In some examples, reducing power consumption in the node 700 comprises inhibiting data transmissions from a subset or all of the router circuits 702(1)-702(D).

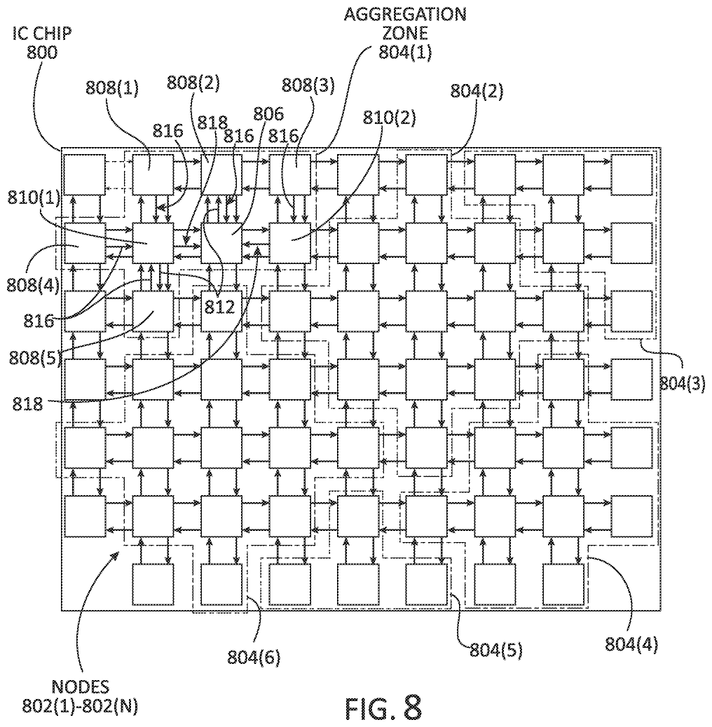

FIG. 8 is a block diagram of an IC chip 800 in which a plurality of nodes 802(1)-802(N) are configured in a second example of aggregation zones 804(1)-804(Z). As an example, the aggregation zone 804(1) may receive indications of power consumption and reduce power consumption in each of the plurality of nodes 806, 808(1)-808(5), 810(1), and 810(2) to mitigate voltage droops. In this example, the aggregation zones 804(1)-804(Z) are configured differently than in FIG. 5. Aggregation zone 804(1) is described as an example that may be applicable to any of the aggregation zones 804(1)-804(Z). In this example, there are six (6) aggregation zones 804(1)-804(6) (where Z=6).

Aggregation zone 804(1) includes a first, leader node 806 in which the aggregation circuit 400 (FIG. 4) is configured in the first, leader mode of operation. The aggregation zone 804(1) also includes second, follower nodes 808(1)-808(5). In addition, the aggregation zone 804(1) includes third, middle nodes 810(1) and 810(2). In contrast to the aggregation zone 504(1) in FIG. 5, in which all the follower nodes 512(1)-512(4) were adjacent to the leader node 510, which may be referred to as one “hop” away from the leader node 510 over one of the segments 506, the follower nodes 808(1), 808(3), 808(4), and 808(5) are not adjacent to (e.g., not one hop away) from the leader node 806. Instead, the middle nodes 810(1) and 810(2) are adjacent to the leader node 806, the follower nodes 808(1), 808(4), and 808(5) are adjacent to the middle node 810(1), and the follower node 808(3) is adjacent to the middle node 810(2). In other words, the follower nodes 808(1), 808(3), 808(4), and 808(6) are two hops away from the leader node 806. It can be seen in FIG. 5 that the follower node 808(2) and the middle node 810(2) could be reversed.

In the aggregation circuit 400 in the middle node 810, the configuration register 406 is configured to selectively control the aggregation circuit 400 to operate in a third mode. It should be recognized that the aggregation circuit 400 in any of the nodes 802(1)-802(N) may be configured in any one of the first mode, the second mode, or the third mode, depending on the aggregation zones 804(1)-804(Z). In the third mode, the aggregation circuit 400 in the middle node 810 also receives indications 514 and 518, as shown in FIG. 5 (not shown here) as signals 414P at inputs 402 (see FIG. 4), indicating power consumption associated with the middle node 810. The middle nodes 810(1) and 810(2) also receive indications 816 from the adjacent follower nodes 808(1), 808(3), 808(4), and 808(5), which correspond to the indications 520 from the follower nodes 512(1)-512(4) received in the leader node 510 in FIG. 5. However, unlike the leader nodes 510 in FIGS. 5 and 806 in FIG. 8, the middle nodes 810(1) and 810(2) each generate an indication 818 (also like the indication 520) based on the indications 514, 518, and 816 and provides the indications 818 to the leader node 806. The follower nodes 808(2) and 808(5) also generate indications 816 based on their own received indications 812. The leader node 806 receives the indication 816 from the follower nodes 808(2). The middle node 810(1) aggregates the indications 816 from the follower nodes 808(1), 808(4), and 808(5) and provides the indication 818 to the leader node 806. Based on the indications 816 and 818 from the follower nodes 808(2) and 808(5) and the middle node 20) 810, the leader node 806 generates the control signal 522 as shown in FIG. 5 (not shown here to avoid congestion) and provides the control signal 522 to the follower nodes 808(2) and the middle nodes 810(1) and 810(2). The middle nodes 810(1) and 810(2) receive the control signal 522 and provides the control signal 522 to the follower nodes 808(1), 808(3), 808(4), and 808(5). In this manner, the leader node 806 receives indications of power consumption from all of the nodes in the aggregation zone 804(1) and, based on such indications, provides the control signal 522 to reduce power consumption in all the nodes in the aggregation zone 804(1). In this regard, a larger or differently shaped region of the IC chip 800, compared to the aggregation zones 504(1)-504(Z) in FIG. 5, may be centrally monitored for power consumption by the leader node 806 and uniformly controlled to avoid voltage droops in a region of the IC chip 800. In the middle nodes 810(1) and 810(2), the control signal 522 received from the leader node 806 is one of the signals 414C received on the inputs 402 of the aggregation circuit 400.

FIG. 9 is a block diagram of an IC chip 900 in which a plurality of nodes 902(1)-902(N) are configured in a third example having only aggregation zone 904 that receives indications of power consumption and reduces power consumption in each of the plurality of nodes in the aggregation zone 904 to mitigate voltage droops in the IC chip 900. The aggregation circuits 400 in each of the plurality of nodes 902(1)-902(N) are configured to operate in one of the first, leader mode, the second, follower mode, and the third, middle mode. The aggregation zone 904 includes a leader node 906 and a plurality of second, follower nodes 908(1)-908(F), but the aggregation zone 904 differs from the aggregation zone 804(1) in FIG. 8 primarily by having multiple levels of middle nodes 910(1)-910(M). Each middle node 910(1)-910(M) essentially operates in the same manner as the middle node 810 in FIG. 8, receiving indications of power consumption from up to four adjacent nodes, but such nodes may be any combination of middle nodes 910(1)-910(M) and follower nodes 908(1)-908(F). Rather than receiving a control signal directly from the leader node 906, the middle nodes 910(1)-910(M) may receive control signals from another one of the middle nodes 910(1)-910(M). In this configuration, the voltage consumption indications of all of the plurality of nodes 902(1)-902(N) may be considered, and a control signal based on such indications may be employed in all of the plurality of nodes 902(1)-902(N) to reduce power consumption to mitigate voltage droop across the IC chip 900. In the example shown in FIG. 9, a mesh network 912 extends over an area A of the IC chip 900, and the leader node 906 is disposed in a center portion of the area A. Locating the leader node 906 in a central portion may optimize the number of hops from the follower nodes 908(1)-908(F) to the leader node 906.

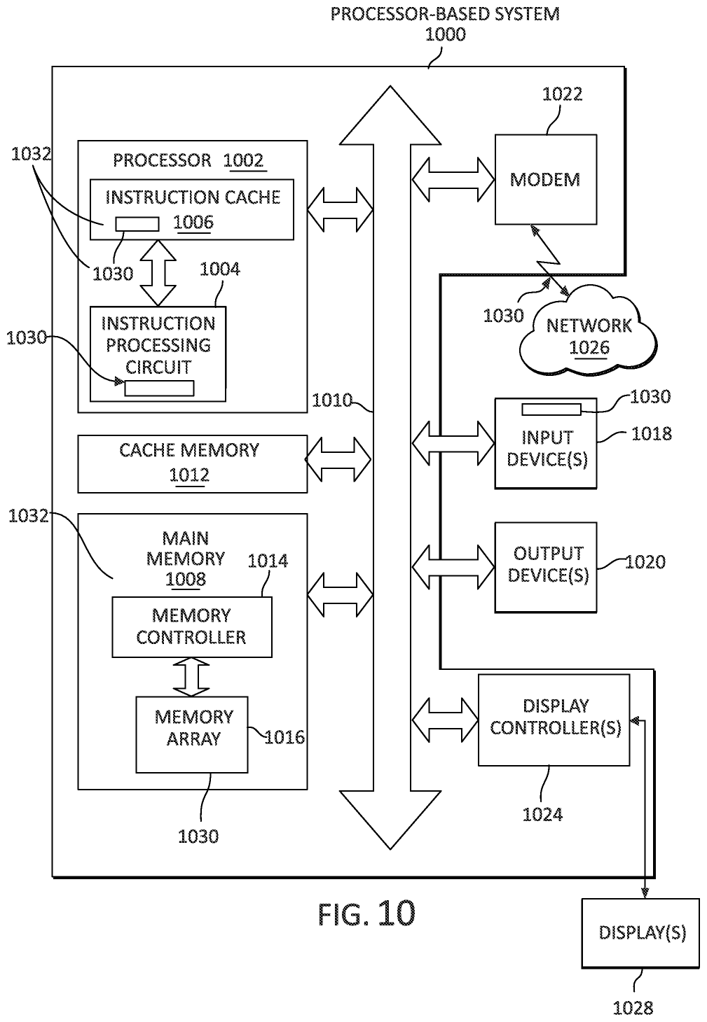

FIG. 10 is a block diagram of an exemplary processor-based system 1000 that includes a processor 1002 (e.g., a microprocessor) that includes an instruction processing circuit 1004 coupled to a mesh network comprising a plurality of nodes that each includes an aggregation circuit configured to employ aggregation zones to receive indications of power consumption and reduce power consumption in each of the plurality of nodes, as illustrated in FIGS. 5, 7, and 8. Any of the processor-based system 1000, the processor 1002, and the instruction processing circuit 1004 can be the IC chip 100 in FIG. 1 as an example. The processor-based system 1000 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer.

In this example, the processor 1002 represents one or more general-purpose processing circuits, such as a microprocessor, central processing unit, or the like. The processor 1002 is configured to execute processing logic in instructions for performing the operations and steps discussed herein. In this example, the processor 1002 includes an instruction cache 1006 for temporary, fast access memory storage of instructions accessible by the instruction processing circuit 1004. Fetched or prefetched instructions from a memory, such as from the cache memory 1012 over a system bus 1010, are stored in the instruction cache 1006. The instruction processing circuit 1004 is configured to process instructions fetched into the instruction cache 1006 and process the instructions for execution.

The processor 1002 and the cache memory 1012 are coupled to the system bus 1010 and can intercouple peripheral devices included in the processor-based system 1000. As is well known, the processor 1002 communicates with these other devices by exchanging address, control, and data information over the system bus 1010. For example, the processor 1002 can communicate bus transaction requests to a memory controller 1014 in the main memory 1008 as an example of a slave device. Although not illustrated in FIG. 10, multiple system buses 1010 could be provided, wherein each system bus constitutes a different fabric. In this example, the memory controller 1014 is configured to provide memory access requests to a memory array 1016 in the main memory 1008. The memory array 1016 is comprised of an array of storage bit cells for storing data. The main memory 1008 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 1010. As illustrated in FIG. 10, these devices can include the main memory 1008, one or more input device(s) 1018, one or more output device(s) 1020, a modem 1022, and one or more display controllers 1024, as examples. The input device(s) 1018 can include any type of input device, including but not limited to input keys, switches, voice processors, etc. The output device(s) 1020 can include any type of output device, including but not limited to audio, video, other visual indicators, etc. The modem 1022 can be any device configured to allow exchange of data to and from a network 1026. The network 1026 can be any type of network, including but not limited to a wired or wireless network, a private or public network, a local area network (LAN), a wireless local area network (WLAN), a wide area network (WAN), a BLUETOOTH™ network, and the Internet. The modem 1022 can be configured to support any type of communications protocol desired. The processor 1002 may also be configured to access the display controller(s) 1024 over the system bus 1010 to control information sent to one or more displays 1028. The display(s) 1028 can include any type of display, including but not limited to a cathode ray tube (CRT), a liquid crystal display (LCD), a plasma display, etc.

The processor-based system 1000 in FIG. 10 may include a set of instructions 1030 to be executed by the processor 1002 for any application desired according to the instructions. The instructions 1030 may be stored in the main memory 1008, processor 1002, and/or instruction cache 1006 as examples of a non-transitory computer-readable medium 1032. The instructions 1030 may also reside, completely or at least partially, within the main memory 1008 and/or within the processor 1002 during their execution. The instructions 1030 may further be transmitted or received over the network 1026 via the modem 1022, such that the network 1026 includes the computer-readable medium 1032 while the computer-readable medium 1032 is shown in an exemplary embodiment to be a single medium, the term “computer-readable medium” should be taken to include a single medium or multiple media (e.g., a centralized or distributed database and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product or software that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., ROM, random access memory (“RAM”), a magnetic disk storage medium, an optical storage medium, flash memories, etc.), and the like.

Unless specifically stated otherwise and as apparent from the previous discussion, it is appreciated that throughout the description, discussions utilizing terms such as “processing.” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. Alternatively, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An integrated circuit (IC) chip comprising:
a plurality of nodes in a mesh network;
a first aggregation zone comprising a first node and at least a second node of the plurality of nodes,
wherein:
each node of the plurality of nodes comprises an aggregation circuit configured to receive a first indication of power consumption associated with the node;
the aggregation circuit in the first node is configured to, in response to operating in a first mode:
receive at least a second indication of power consumption associated with each of the at least a second node; and
provide a first control signal based on the first indication and the at least a second indication to each node of the at least a second node; and
the aggregation circuit in each of the first node and the at least a second node is configured to reduce power consumption in the node in response to the first control signal.

2. The IC chip of claim 1, the aggregation circuit in each node of the plurality of nodes, comprises a configuration register configured to selectively control the aggregation circuit to operate in one of the first mode and a second mode.

3. The IC chip of claim 1, wherein the aggregation circuit in each of the at least a second node is configured to operate in the second mode.

4. The IC chip of claim 1, further comprising at least a second aggregation zone comprising a third node and at least a fourth node, wherein:
the aggregation circuit in the third node is configured to operate in the first mode; and
the aggregation circuit in each of the third node and the at least a fourth node is configured to reduce power consumption in the node in response to a second control signal provided by the third node.

5. The IC chip of claim 1, wherein:
the mesh network further comprises segments, each coupled between two nodes of the plurality of nodes adjacent to each other; and
each node of the plurality of nodes is coupled to at least two segments of the mesh network.

6. The IC chip of claim 5, wherein the first node in the first aggregation zone is adjacent to each of the at least a second node.

7. The IC chip of claim 6, wherein the at least a second node comprises up to four nodes of the plurality of nodes adjacent to the first node.

8. The IC chip of claim 7, wherein the aggregation circuit in the first node is further configured to identify each node of the at least a second node among the plurality of nodes adjacent to the first node.

9. The IC chip of claim 6, wherein:
the first aggregation zone further comprises at least a fifth node;
each node of the at least a fifth node is adjacent to one of the at least a second node;
the aggregation circuit in each of the at least a second node adjacent to at least one of the at least a fifth node is configured to:
receive at least a third indication of power consumption associated with each of the at least one of the at least a fifth node;
provide the at least a third indication to the first node; and
provide the first control signal to each of the at least one of the at least a fifth node; and
the first node is further configured to provide the first control signal based on the at least a third indication.

10. The IC chip of claim 6, wherein:
the aggregation circuit in each node of the plurality of nodes is further configured to selectively control the aggregation circuit to operate in a third mode;
each of the at least a second node comprises the aggregation circuit configured to operate in the third mode; and
the aggregation circuit in each of the at least a fifth node is configured to operate in the second mode.

11. The IC chip of claim 1, wherein:
the first aggregation zone comprises the plurality of nodes on the IC chip;
the mesh network extends over a first area of the IC chip; and
the first node is disposed in a center portion of the first area.

12. The IC chip of claim 1, further comprising a voltage comparator configured to compare a power supply voltage to a threshold, wherein in each node of the plurality of nodes, the first indication of power consumption associated with the node comprises an output from the voltage comparator.

13. The IC chip of claim 1, wherein:
at least one node of the plurality of nodes is coupled to a corresponding processing circuit; and
in the at least one node coupled to a corresponding processing circuit, the first indication of power consumption associated with the node comprises an indication from the corresponding processing circuit of an event related to a data transmission.

14. The IC chip of claim 1, wherein:
each node of the plurality of nodes further comprises a plurality of router circuits configured to transmit data on a segment of the mesh network; and
in each node of the plurality of nodes, reducing power consumption in the node comprises inhibiting data transmissions from at least a subset of the plurality of router circuits in the node.

15. A method in an integrated circuit (IC) chip, the method comprising:
in a first aggregation zone comprising a first node and at least a second node of a plurality of nodes in a mesh network,
receiving, in an aggregation circuit in each node of the plurality of nodes, a first indication of power consumption associated with the node;
in response to the aggregation circuit in the first node configured to operate in a first mode:
receiving, in the first node, at least a second indication of power consumption associated with each of the at least a second node; and
providing a first control signal based on the first indication and the at least a second indication to each node of the at least a second node; and
in the aggregation circuit in each of the first node and the at least a second node, reducing power consumption in the node in response to the first control signal.

16. The method of claim 15, further comprising, in each node of the plurality of nodes, configuring a configuration register to selectively control the aggregation circuit to operate in one of the first mode and a second mode.

17. The method of claim 15, further comprising configuring the aggregation circuit in each of the at least a second node to operate in the second mode.

18. The method of claim 15, further comprising, in a second aggregation zone comprising a third node and at least a fourth node:
configuring the aggregation circuit in the third node to operate in the first mode; and
in the aggregation circuit in each node of the third node and the at least a fourth node, reducing power consumption in the node in response to a second control signal provided by the third node.

19. The method of claim 15, further comprising:
configuring the aggregation circuit in each node of the at least a second node to:
receive at least a third indication of power consumption associated with one of at least a fifth node coupled to the node;
provide the at least a third indication to the first node; and
provide the first control signal to each of the at least one of the at least a fifth node; and
providing, by the first node, the first control signal based on the at least a third indication.

20. The method of claim 16, wherein:
configuring the aggregation circuit in each node of the plurality of nodes to selectively control the aggregation circuit to operate in a third mode;
in each of the at least a second node, configuring the aggregation circuit to operate in the third mode; and
configuring the aggregation circuit in each of the at least a fifth node to operate in the second mode.

21. The method of claim 15, further comprising:
in a voltage comparator, comparing a power supply voltage to a threshold; and
receiving the first indication of power consumption associated with the node in each node of the plurality of nodes further comprises receiving an output of the voltage comparator.

22. The method of claim 15, wherein:
in each node of at least one node in the plurality of nodes, receiving the first indication of power consumption associated with the node further comprises receiving an indication from a processing circuit coupled to the node of an event related to a data transmission.

23. The method of claim 15, wherein, in each node of the plurality of nodes, reducing power consumption in the node comprises inhibiting data transmissions from at least a subset of a plurality of router circuits configured to transmit data from the node.
